(19) United States
(12) Patent Application Publication
(10) Pub. No.: US 2021/0378221 A1
(43) Pub. Date: Dec. 9, 2021

(54) DEVICE FOR BALANCING A FISHING ROD

(71) Applicant: Igor Nazhmitdinovich BAGAUTDINOV, Chelyabinsk (RU)

(72) Inventor: Igor Nazhmitdinovich BAGAUTDINOV, Chelyabinsk (RU)

(21) Appl. No.: 17/281,782

(22) PCT Filed: Jan. 9, 2020
(86) PCT No.: PCT/RU2020/000002

§ 371 Date: Mar. 31, 2021

(30) Foreign Application Priority Data
Feb. 7, 2019 (RU) 2019103415

(51) Int. Cl. A01K 97/00

(52) U.S. Cl. CPC A01K 97/00

(57) ABSTRACT

The invention relates to fishing accessories and it is used for balancing a fishing rod, fishing spinning, etc. The technical result is to improve the characteristics of the fishing rod by adjusting the position of the rod's center of gravity. The rod itself does not change. The device is convenient to install on the rod and remove from the rod. The device has the shape of a ring made from elastic material; there are weights inside the ring with a certain mass, depending on the mass of the rod. Weights can be arranged evenly along the circumference or in certain sectors.

### FIELD OF THE INVENTION

The invention relates generally to fishing accessories and particularly to a device for balancing a fishing rod. The invention can be used for balancing a spinning rod or some other form of fishing tackle.

### BACKGROUND OF THE INVENTION

Every angler is faced with the problem of balancing various types of fishing tackle (a float fishing rod, a bottom fishing rod, a spinning rod, a fly-fishing rod, etc.). When fishing, a fishing rod is held in hands, for which reason the distribution of the weight of the fishing rod along its length (i.e. its balance) is important in addition to the weight itself. Particularly high demands are made on spinning and fly-fishing rods. As a result of proper balancing, an angler palm is in the center of the mass of the float fishing rod, spinning rod or other fishing tackle, thereby providing comfortable fishing because the angler palm, hand and back do not fatigue, as well as the high sensitivity of the fishing rod and the accurate casting of a spoonbait or other bait for fish are maintained. This problem may be currently solved in several ways. To make the center of gravity of the fishing rod closer to the hands, a butt is made heavier with a weight. For example, fishing rods having built-in balancing devices are known, but such rods are uncommon and expensive. An individual balancing device is developed for each fishing-rod model and cannot be used in a different fishing-rod model. This problem may be also solved by selecting the mass of each element of the fishing tackle (such as a fishing rod, reel, spoon, sinker, etc.). However, the possibilities of this method are very limited, since, during such a selection, it is necessary to consider not only the weight of the element, but also its technical characteristics. The selected element may be suitable in weight, but completely unsuitable for other characteristics and vice versa, which makes the problem unsolvable in some cases.

KR200174189 discloses a device for solving the problem of balancing a fishing rod. A cover for the fishing rod consists of a threaded sleeve and a cap with a threaded axis, between which a weight may be fixed. The device is screwed into the handle of the fishing rod by means of the threaded sleeve.

The device known from KR200174189 is not flexible and may only be used for fishing rods having an internal thread in their handle. The other disadvantage of the device known from KR200174189 is its fixity, i.e. it is impossible move the device along the length of the handle, which limits the possibility of balancing.

US5355611 discloses a balancer for fishing rods. The balancer comprises an elongated hollow end cap which is mounted at the rear end of a handle of a fishing rod and supports one or more counterweights inside or outside the cap. The counterweights are selected based on their weight increments and number to effectively balance variable-length fishing rods around a fulcrum point defined by a user hand on the handle of the fishing rod at the location of a reel. Similar to the present invention, the balancer known form US5355611 has balancing weights.

The disadvantages of the device known from US5355611 are as follows: the device is fixed, i.e. it is impossible move the device along the length of the handle, which limits the possibility of balancing; the device is not compatible with some handles due to its specific shape; the device lengthens the handle and can fall off during intense movements and when it rests on a thigh or trunk.

FR3053571 discloses a counterweight for a fishing rod. The counterweight is configured as a clamping device having an adjustable fastener. The counterweight is fixed at the end of the handle of the fishing rod and equipped with a weight fixing system. Variable weights may be attached to a support, for example, using a screw, a spring or a “snap” system, in order to adjust the weight to the gram.

The device known from FR3053571 has a complex design in the form of a system of weights fixed to the counterweight. The other disadvantages of the device known from FR3053571 are as follows: the device is fixed, i.e. it is impossible move the device along the length of the handle, which limits the possibility of balancing; the device lengthens the handle and can fall off during intense movements and when it rests on a thigh or trunk, thereby making its utilization complicated. Similar to the present invention, the device known from FR3053571 has balancing weights.

### SUMMARY OF THE INVENTION

The object of the present invention is to provide the possibility of balancing a fishing rod.

The technical result provided by a device for balancing a fishing rod according to the present invention consists in simplifying the device design and improving its operational characteristics, as well as providing the possibility of accurately adjusting the position of the center of mass of the fishing rod without changing the overall parameters of the fishing rod, so that the device does not come loose and does not fall off during operation, does not impede an angler and makes it possible to promptly change the position of the center of gravity of the fishing rod without removing the device or individual weights.

Due to the fact that the device for balancing the fishing rod according to the present invention comprises the weights and a ring made of an elastic material, inside which the weights are arranged, the device design is simplified, its operational characteristics are improved, and the required position of the center of mass of the fishing rod may be accurately adjusted without changing the overall parameters of the fishing rod, for which reason the device does not come loose and does not fall off during its operation, does not impede an angler and makes it possible to promptly change the position of the center of gravity of the fishing rod without removing the device or individual weights.

### Industrial applicability

The device for balancing the fishing rod according to the present invention is industrially applicable, since it can be widely used by anglers to balance various fishing tackle.

### BRIEF DESCRIPTION OF THE DRAWINGS

A device for balancing a fishing rod is explained by using the drawings in which:

FIG. 1 shows the device for balancing the fishing rod, namely its main view with a section;

FIG. 2 shows the device for balancing the fishing rod, namely its main top view with a section;

FIG. 3 shows the exemplary arrangement of the device for balancing the fishing rod on a handle.

### DETAILED DESCRIPTION OF THE INVENTION

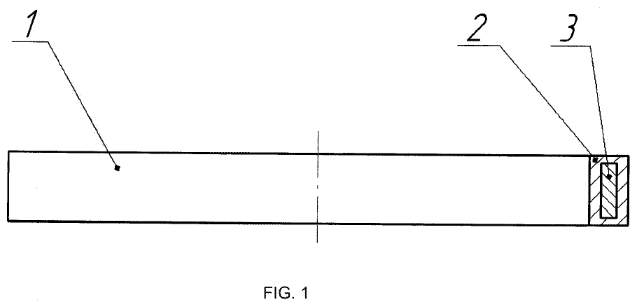

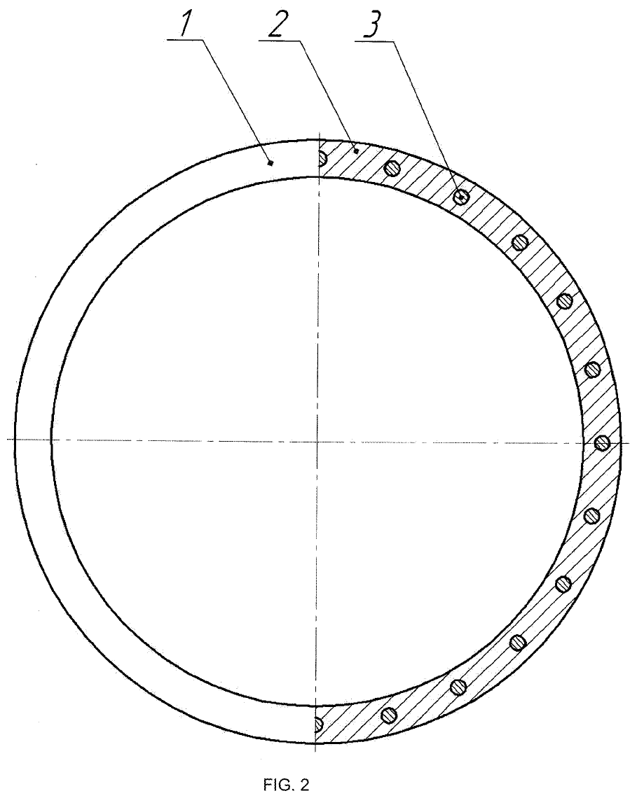

A device 1 for balancing a fishing rod is configured as a ring 2 made of an elastic material, for example, an elastic polymer, inside which weights 3 are arranged. The weights 3 made be made of metal and are insulated from environmental impact by the material of the ring 2 (see FIG. 1). The weights 3 may be arranged uniformly around the circumference of the ring 2 (see FIG. 2) or in sectors.

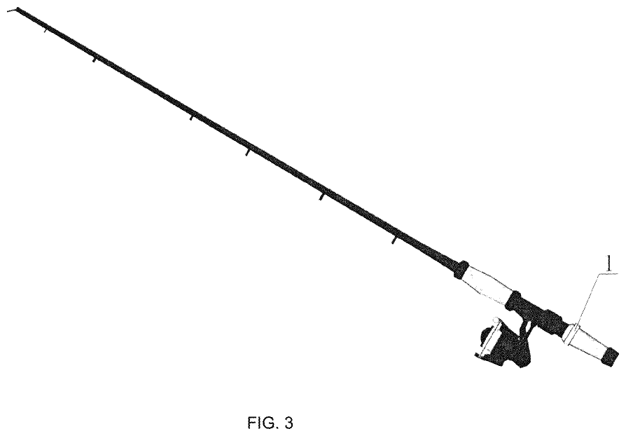

The device 1 for balancing the fishing rod operates as follows. At first, fishing tackle is assembled—a fishing rod, a reel, a fishing line, sinkers, etc. Then, the center of gravity of the assembled fishing tackle is determined. Further, depending on where the center of gravity is provided, the balancing device is put on a handle to balance the fishing rod (see FIG. 3). As is well known, the closer the center of gravity of the fishing rod is to a holding hand, the more convenient it is to hold the fishing rod and cast a rig. Therefore, if the center of gravity is closer to a tip, then it is reasonable to put the balancing device on a butt part of the fishing rod. If the center of gravity is behind the reel and closer to the butt part, it will be necessary to put on the balancing device in front of the reel. Further, shifting the device for balancing the fishing rod along the axis of the fishing rod, one can empirically select the optimal position and weight of the balancing device. When making any changes to the assembled fishing tackle, for example, changing a bait, changing a fishing method, one can promptly adjust the balance of the fishing rod in the same way by shifting the balancing device along the axis. The installation place of the balancing device on the fishing rod will depend on how much and in which direction it is required to shift the center of gravity of the fishing rod. This will satisfy the demands of each angler according to his/her individual preferences. Furthermore, by using such a device for balancing the fishing rod, it is possible for the angler to use a lightweight fishing rod made of modern materials without having to weigh it down with a big-mass reel and other heavy fishing tackle components; on the contrary, it is possible to equip the fishing tackle with a light reel, since balancing may be achieved using the balancing device.

What is claimed is:

1. A device for balancing a fishing rod, comprising weights and a ring made of an elastic polymer, the weights being arranged inside the ring.
